(19) United States
(12) Patent Application Publication
(10) Pub. No.: US 2024/0086470 A1
(43) Pub. Date: Mar. 14, 2024

(54) METHODS AND SYSTEMS FOR IDENTIFYING COMPANIES BASED ON CONTEXT ASSOCIATED WITH A USER INPUT

(71) Applicant: 6SENSE INSIGHTS, INC., San Francisco, CA (US)

(72) Inventors: Gajanan SABHAHIT, Karnataka (IN); Roopam CHOUDHURY, Assam (IN); Mounarajan PARTHIBAN, Nadu (IN); Tarun BANSAL, Delhi (IN); Pratyush BEHERA, Odisha (IN); Arjab SARKAR, West Bengal (IN)

(21) Appl. No.: 18/202,657

(22) Filed: May 26, 2023

Related U.S. Application Data
(63) Continuation of application No. PCT/IB2023/050414, filed on Jan. 18, 2023.

(30) Foreign Application Priority Data
Sep. 8, 2022 (IN) 202221051375

(51) Int. Cl. G06F 16/951; G06Q 30/0201

(52) U.S. Cl. CPC G06F 16/951; G06Q 30/0201

(57) ABSTRACT

Example embodiments for identifying companies based on a context associated with a user input are disclosed. Initially, a user input and pre-stored keyword patterns may be obtained. Multiple data sources may be parsed based on the user input to extract data pertaining to multiple companies. Upon parsing, the extracted data, from each data source, may be compared with the pre-stored keyword patterns. Based on the comparison, the one or more companies may be identified. The identification of the one or more companies is based on a matching of context, thereof, with the context of the user input. Further, a confidence score may be computed for the context of each of the one or more companies. Based on the confidence score, the one or more companies are ranked.

### PRIORITY INFORMATION

The present application is a bypass continuation of International Patent Application No. PCT/IB2023/050414, filed on 18^{th} Jan., 2023, which claims priority from Indian Application No. 202221051375 filed on 08^{th} Sep., 2022, which are both hereby incorporated herein by reference as if set forth in full.

### TECHNICAL FIELD

The present subject matter described herein relates, in general, to a method and system for identifying companies based on a context associated with a user input.

### BACKGROUND

Various strategies are employed for extracting information from a collection of web addresses, based on a user input including a keyword, in an organized manner. Such mechanisms involve a set of rules for allowing a web parsing application to identify a set of web addresses based on the input keyword(s).

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for identifying companies based on context associated with a user input. This summary is not intended to identify essential features of the claimed subject matter nor is it intended for use in determining or limiting the scope of the claimed subject matter.

In an implementation, a method for identifying companies based on a context associated with a user input is disclosed. The method includes obtaining the user input and pre-stored keyword patterns. Based on the user input, a plurality of data sources may be parsed to extract data pertaining to a plurality of companies. Thereafter, the extracted data, from each data source, may be compared with the pre-stored keyword patterns. Based on the comparison, the one or more companies from the plurality of companies may be identified. In an example, a context of the one or more companies matches with the context of the user input. The method further includes computing a confidence score for the context of each of the one or more companies. Based on the confidence score, the one or more companies may be ranked.

In another implementation, a system for identifying companies based on a context associated with a user input is disclosed. The system includes a memory and a processor to execute program instructions stored in the memory. The processor may execute instructions to obtain the user input and pre-stored keyword patterns. The processor may further execute instructions to parse a plurality of data sources based on the user input to extract data pertaining to a plurality of companies. Further, the processor may execute instructions to compare, the extracted data, from each data source, with the pre-stored keyword patterns. Based on the comparison, the one or more companies may be identified from the plurality of companies. In an example, a context of the one or more companies matches with the context of the user input. The processor may also execute instructions to compute a confidence score for the context of each of the one or more companies. Based on the confidence score, the one or more companies are ranked.

In yet another implementation, a non-transitory computer readable medium embodying a program executable in a computing device for identifying companies based on context associated with a user input is disclosed. The program may comprise a program code to obtain the user input and pre-stored keyword patterns. The program may comprise a program code to parse a plurality of data sources based on the user input to extract data pertaining to a plurality of companies. Further, the program may comprise a program code to compare, the extracted data, from each data source, with the pre-stored keyword patterns. Based on the comparison, the one or more companies may be identified from the plurality of companies. In an example, a context of the one or more companies matches with the context of the user input. The program may comprise a program code to compute a confidence score for the context of each of the one or more companies. Based on the confidence score, the one or more companies are ranked.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for identifying companies based on context associated with a user input disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network environment implementing a system for identifying companies based on context associated with a user input, in accordance with an embodiment of the present subject matter;

FIG. 2 illustrates a system for identifying companies based on context associated with a user input, in accordance with an embodiment of the present subject matter; and

FIG. 3 illustrates a method for identifying companies based on context associated with a user input, in accordance with an embodiment of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “obtaining”, “parsing”, “comparing”, “identifying”, “computing”, “ranking”, and other forms thereof, are intended to be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

In the specification, reference to “one embodiment” or “an embodiment” indicates that a particular feature, structure, or characteristic described in connection with the embodiment is included in at least one embodiment of the invention. The appearances of the phrase “in one embodiment” at different places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

Websites are a collection of web pages having corresponding web addresses. The web addresses include different forms of information, such as post data including post categories, types of web contents including images and text, and user interface elements including inputs controls and navigational components. One or more web addresses may pertain to a company or organization, such as an E-commerce company, an educational institution, a financial institution, and so on. Data of interest from such web addresses may be extracted for providing insights. To extract such data, web parsing applications are employed. The extraction of such data of interest may be based on a search term defined by an input keyword(s). In order to extract the information, different levels of a target web address are navigated to match content(s) of each web page with the input keyword(s). The output results are populated based on the matched content(s).

In order to parse multiple levels of web addresses in a structured manner, existing web parsing applications execute a plurality of parsing instances. Execution of the plurality of parsing instances is based on identification of matches of content(s) related to a keyword in a particular web address. In addition, the web parsing applications may execute a plurality of parsing instances, based on the identification of matches, in order to extract the set of follow-up web addresses from an individual level of web addresses. Conventional web parsing applications execute each of the plurality of parsing instances based on a broad match of the content of the web addresses as the matching is based on only the keyword.

However, executing the plurality of parsing instances based only on the keyword may provide inaccurate parsing output from the web parsing application. For example, the web address may include content(s) which includes the keyword or terms which are matching with the keyword. However, a relevancy of the matching content(s) with the keyword may be low. For example, the matching content(s) may not be directed to a context similar to a context defined by the keyword. Further, a context associated with the content(s), based on which the content(s) is related with rest of the portion of a corresponding web page, plays a critical role in execution of parsing instances for a particular category of a company. The parsing output from such web parsing applications may include web addresses pertaining to companies which may not have same context as per the user's intent. Thus, exclusion of the context being associated with the web address or the set of web addresses in implementation of the web parsing applications may result in inaccuracy in the parsing output. Therefore, conventional web parsing applications are unable to accurately implement parsing instances for accessing the information from the web addresses.

To be able to accurately parse a web address, web parsing applications may first detect similar term(s) or phrase(s) related to the keyword. Further, the web parsing applications may navigate a web address associated with a company to identify matching content based on the combination of the keyword and the detected term(s) or phrase(s). However, the detected term(s) or phrase(s) may not be precisely directed to the context on which the identified content is defined. Thus, detection of the term(s) or phrase(s) similar to the keyword for different levels of the web address may be inaccurate in terms of context while being time consuming and may require large amounts of computational resources.

The present subject matter describes various approaches for identifying one or more companies based on a context associated with a user input. The present subject matter facilitates identifying multiple companies having a theme or a context similar to the context of the user input with accuracy and in a time efficient manner.

In an embodiment of the present subject matter, a system is configured to obtain a user input including one or more keywords based on which the system may identify the companies. The one or more keywords may be defined as a word or a phrase which is specified by a user for performing a search. Further, the system may obtain one or more keyword patterns. Each of the one or more keyword patterns may be indicative of a word or a phrase which is contextually similar to the one or more keywords. The one or more keyword patterns may be defined and classified based on different categories and sub-categories of a theme or context associated with a company. For example, each keyword pattern from the one or more keyword patterns is related to a theme or a context which is associated with a corresponding web address. The system may execute one or more parsing instances to parse each web address associated with the plurality of data sources, based on the user input including one or more keywords, to extract information from the web addresses. For example, the system may parse a plurality of data sources to extract data pertaining to a plurality of companies. Each data source from the plurality of data sources may be indicative of a location in the public domain from which the data is to be parsed. In addition, the system may execute one or more parsing instances to parse multiple depth levels of each web address.

Further, the system may extract data related to each depth level of the web addresses, based on the user input. Upon extraction, the system may compare the extracted data with the set of pre-defined keyword patterns. Thereafter, based on the comparison, the system may identify one or more companies. The identified one or more companies may be contextually similar to the user input. Such identification assists in eliminating the companies which have a theme or a context which is not similar to the user input. Therefore, the system, as per the present subject matter, may accurately produce results based on the context of the user input. Such context-based approach for identification of the target companies reduces requirement of large computational resources for determining the theme or the context pertaining to a plurality of companies. Further, such approaches, implemented by the system of the present subject matter, reduce the overall time required for identification of the respective companies.

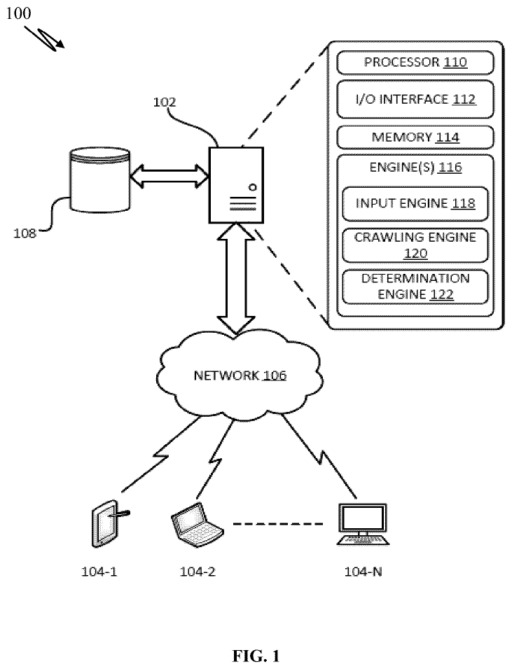

These and other advantages of the present invention would be described in greater detail in conjunction with FIGS. 1 to 3 in the following description. The manner in which the systems and methods of the present subject matter are implemented shall be explained in detail with respect to FIGS. 1 to 3. It should be noted that the description merely illustrates the principles of the present invention. It will thus be appreciated that those skilled in the art will be able to devise various arrangements that, although not explicitly described herein, embody the principles of the present invention and are included within its scope. Furthermore, all examples recited herein are intended only to aid the reader in understanding the principles of the present invention. Moreover, all statements herein reciting principles, aspects, and implementations of the present invention, as well as specific examples thereof, are intended to encompass equivalents thereof.

FIG. 1 illustrates a network environment 100 implementing a system 102 for identifying companies based on a context associated with a user input, in accordance with an embodiment of the present subject matter. The network environment 100 may either be a public distributed network environment or a private closed network environment. The network environment 100 may include different user devices 104-1, 104-2, . . . , 104-N, communicatively coupled to the system 102 through a network 106. For the sake of explanation, the user devices 104-1, 104-2, . . . , 104-N, have been collectively referred to as user devices 104 and individually referred to as a user device 104, hereinafter.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, and a cloud-based computing environment. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation, through which the user may provide input to the system 102.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

The network environment 100 further comprises a database 108 communicatively coupled to the system 102. The database 108 may store data pertaining to multiple web addresses that are parsed by the system 102. In an example, the database 108 may store all web pages that are parsed by the system 102. Although the database 108 is shown as a separate entity in the network environment 100, it will be appreciated by a person skilled in the art that the database 108 can also be internal to the system 102.

In one embodiment, the system 102 may include at least one processor 110, an input/output (I/O) interface 112, a memory 114, and engine(s) 116. The at least one processor 110 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 110 is configured to fetch and execute computer-readable instructions stored in the memory 114.

The I/O interface 112 may include a variety of software and hardware interfaces, for example, a web interface, a graphical user interface, and the like. The I/O interface 112 may allow the system 102 to interact with the user directly or through the user devices 104. Further, the I/O interface 112 may enable the system 102 to communicate with other computing devices, such as web servers and external data servers (not shown). The I/O interface 112 can facilitate multiple communications within a wide variety of networks and protocol types, including wired networks, for example, LAN, cable, etc., and wireless networks, such as WLAN, cellular, or satellite. The I/O interface 112 may include one or more ports for connecting a number of devices to one another or to another server.

The memory 114 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 114 may include routines, programs, objects, components, data structures, etc., which perform particular tasks or implement particular abstract data types. The memory 114 may include programs or coded instructions that supplement applications and functions of the system 102. In one embodiment, the memory 114, amongst other things, serves as a repository for storing data processed, received, and generated by one or more of the programs or the coded instructions.

The engine(s) 116, amongst other things, includes routines, programs, objects, components, and data structures, which perform particular tasks or implement particular abstract data types. The engine(s) 116 may also be implemented as, signal processor(s), state machine(s), logical circuitries, and/or any other device or component that manipulates signals based on operational instructions. Further, the engine(s) 116 can be implemented by hardware, by computer-readable instructions executed by a processing unit, or by a combination thereof. In one example, the engine(s) 116 may include programs or coded instructions that supplement the applications or functions performed by the system 102. In one implementation, the engines 116 include, for example, an input engine 118, a crawling engine 120, and a determination engine 122.

In an embodiment, the system 102 may be configured to identify one or more companies based on a context associated with a user input. In an example, the user input may include one or more keywords based on which the system 100 may identify the companies. A keyword may be understood as a word, or a phrase specified by the user for performing a search. In an example, the user may input “apparel” as a keyword. In another example, to specify the requirements, the user may put “apparel” and “e-commerce” as the keywords.

In addition, the input engine 118 may obtain pre-stored keyword patterns. In an example, a keyword pattern, from the pre-stored keyword patterns, may be indicative of a word or a phrase that is contextually similar as a particular keyword. Each keyword has one or more corresponding keyword patterns. These one or more keyword patterns may be manually validated by a team of experts to ensure that any false keyword pattern is not considered for company identification. In an example, to obtain the pre-stored keyword patterns, the input engine 118 determines different categories and sub-categories of a context associated with a company under which the pre-stored keyword patterns are classified. These categories and sub-categories may also be manually validated by a team of experts to ensure that any incorrect category or sub-category is not considered for company identification.

Consider an example—a user enters the keyword “logistics.” The input engine 118 may obtain the pre-stored keyword patterns related to “logistics”, such as international shipping, inventory management, supply chain management, transportation, warehouse operations, etc.

In an example, the input engine 118 may obtain the pre-stored keyword patterns from the memory 110 of the system 102. For example, if a user enters keywords “drafting” and “legal” as the input, the input engine 118 may obtain keyword patterns related to “legal”+“drafting”, such as contract drafting, agreement drafting, etc.

Based on the user input, the crawling engine 120 may parse a plurality of data sources to extract data pertaining to a plurality of companies. A data source may indicate any location in the public domain from where the data is parsed for the purposes of present invention. For example, data exists in the public domain in different storages and types. The data may exist in a home page of a company as a slogan or in fragments of a code that has been used for building a website or may be available in a careers page. For the purposes of the present invention, the plurality of data sources may include, web addresses of companies, web addresses of job listings posted by companies, and web addresses of employee profiles that may be published on company websites. In addition to the above-listed data sources, the data sources may include web addresses of annual reports of companies, web addresses of blogs and feeds, web addresses of articles published by senior authorities of companies, and so on.

In an example, the crawling engine 120 may parse multiple depth levels of a web address. Depth level of a web address may indicate a number of levels inside the web address and these levels are determined by the inputs or clicks a user has to provide from a home page. In case of a web address of a company, a home page is considered as depth level 0. A web page which is accessed from the home page or depth level 0 is considered as depth level 1. A web page which is accessed from the depth level 1 is considered as depth level 2, and so on. In an implementation, the crawling engine 120 may parse up to four depth levels of the web address of the companies.

In an example, the crawling engine 120 may be a computer program that crawls and navigates through web addresses using different links available in the web addresses and extracts data out of each webpage associated with the web address. In an implementation, the crawling engine 120 may fetch web pages associated with the web address and extract hyperlinks (i.e., URLs) to other web pages.

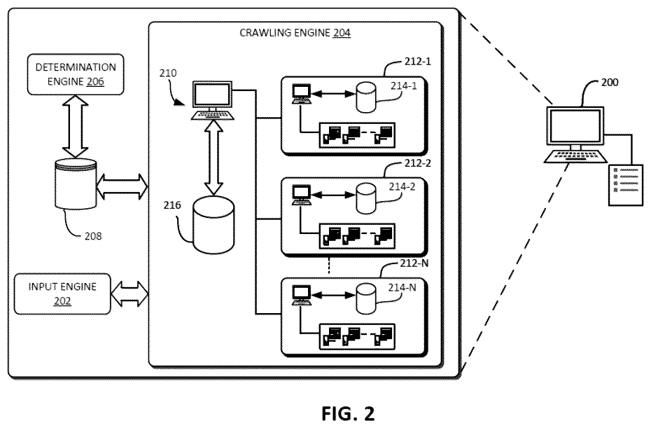

In an embodiment, the crawling engine 120 may employ distributed data processing architecture to facilitate bulk parsing of the data sources. For example, the crawling engine 120 may spawn a plurality of worker nodes to parse the multiple data sources. For example, each worker node of the plurality of worker nodes is allocated a set of data sources for traversal and data extraction. Details regarding the distributed data processing architecture are explained in conjunction with FIG. 2.

In an embodiment, the crawling engine 120 may store the data (such as HTML, data, job listing data, etc.) extracted from the plurality of data sources in a storage unit, such as the database 108. In an example, the database 108 may store the extracted data in a file system to indicate data extracted by each of the plurality of worker nodes. Further, the crawling engine 120 may compare the extracted data from each data source with the pre-stored keyword patterns. For example, comparing the extracted data comprises matching the keyword patterns using a string and pattern matching technique. Examples of the string and pattern matching technique may include, but are not limited to, Aho-Corasick technique, KMP technique. In an example, the crawling engine 120 employs an aho-corasick technique for comparing the pre-stored keyword patterns.

In an example, the determination engine 122 may identify the one or more companies from the plurality of companies, based on the comparison. In an example, the determination engine 122 may shortlist a set of companies that may have a context similar to the context of the user input. Thus, the determination engine 122 may filter out all non-contextual companies which although may contain the keywords from the user input, may not have a same theme as per the user's intent. Thus, the determination engine 122 facilitates in helping the user get faster and more accurate results based on the input (keywords) provided by the user.

In an embodiment, the determination engine 122 may also compute a confidence score for the context of each of the one or more companies. The determination engine 122 may compute the confidence score based on various parameters. In an example, for computing the confidence score, the determination engine 122 may determine a type of data source, a frequency of occurrence of the keyword patterns, number of data sources, and so on. While computing the confidence score, the determination engine 122 may associate a weight with the context of each company from the one or more companies.

For example, the determination engine 122 may associate more weight, such as 60% weight, to a home page or depth level 0 of a web address. Therefore, if a keyword pattern is identified at the home page or depth level 0 of the web address, the context associated with the company would be provided a higher confidence score. In another example, the determination engine 122 may associate more weight, such as 70% weight, to a post or article written by a senior executive of a company. Thus, if a keyword pattern is identified in the post or article written by the senior executive of a company, the context associated with the company would be provided a higher confidence score. In yet another example, if a keyword pattern appears in the data associated with the multiple data sources (such as web addresses, job listing data, blog data, etc.) related to a company, the context associated with the company would be provided a higher confidence score.

Based on the confidence score, the determination engine 122 may rank the one or more companies. In an example, the determination engine 122 may rank the one or more companies in any order of the confidence score. Furthermore, the determination engine 122 may generate a report to indicate the one or more keywords input by the user and the confidence score for the one or more companies associated with the keywords. The confidence score may indicate how relevant a company is for a particular context or theme. Thus, the user may get a list of all companies that have the same theme or context as that of the user input.

For example, if the user enters keywords “equity” and “invest” as the input, the input engine 118 may obtain keyword patterns related to “equity”+“invest”. Thereafter, the crawling engine 120 may parse multiple data sources, such as web addresses, job listing data, etc., that may be related to the user input. Based on the parsing, the pre-stored keyword patterns, such as equity investment, related to the user input may be matched with the data associated with the multiple data sources. Based on the comparison, those companies may be identified which have a similar context as that of the user input. For example, the crawling engine 120 may identify financial institutions or trading companies based on the user input. Upon identification, a confidence score may be computed for each financial institution or trading company. The confidence score may be computed by the determination engine 122 based on determine a type of data source (company website, a blog, a job listing data), a frequency of occurrence of the keyword patterns (higher frequency of occurrence indicates higher relevancy), number of data sources (how many data sources have mapped to the keyword patterns), and so on. Accordingly, the system 100 may provide a rank to the identified trading companies or financial institutions before providing the list of companies to the user.

FIG. 2 illustrates a system 200 for identifying companies based on context associated with a user input, in accordance with an embodiment of the present subject matter. The system 200 may intelligently parse through content stored in the plurality of data sources. The system 200 includes an input engine 202, a crawling engine 204, and a determination engine 206. In the present embodiment, the input engine 202 may be implemented through a database 208 to store a list or queue of web addresses pertaining to the data sources which are to be parsed. The database 208 may act as a Storm spout, such as a Kafka spout.

In an embodiment, the crawling engine 204 is implemented by distributed real-time data processing architecture, such as Apache Storm. The crawling engine 204 may further be implemented through a master node 210 and a plurality of worker nodes 212-1, 212-2, . . . , 212-N. For the sake of explanation, the plurality of worker nodes 212-1, 212-2, . . . , 212-N, have been collectively referred to as worker nodes 212 and individually referred to as a worker node 212, hereinafter. Each worker node 212 may be capable of running one or more parsing processes. The database 208 may provide data as tuples stream to the master node 210. The master node 210 may act as a Storm bolt in the Apache Storm architecture. In an example, tuples are the main data structures in Apache Storm. Tuples are named lists of values, such as integers, longs, shorts, bytes, doubles, strings, Booleans, floats, byte arrays, and so on. The master node 210 may be configured to spawn up the worker nodes 212. Each of the worker nodes 212 may execute a parsing process to parse web addresses listed in the database 208. In an example, the master node 210 may serve as a scheduler to instruct the parsing processes to initiate the parsing.

Considering an example in which the master node 210 is provided a list of 100 million web addresses for being parsed. The master node 210 may spawn 10 worker nodes 212 and distribute the 100 million web addresses amongst the 10 worker nodes. Accordingly, each worker node 212 may be allocated a set of web addresses, i.e., 10 million web addresses for parsing. The worker nodes 212 may parse the web addresses as instructed by the master node 210. In the present example, the master node 210 may specify a degree of depth level up to which each web address is to be parsed by the worker nodes 212. Indicating the degree of depth levels for parsing may provide quicker results. In a preferred embodiment, each worker node 212 may be instructed to parse up to four depth levels for each web address.

In an example, the worker nodes 212 may send, in real-time, any new web addresses that may be found during parsing a web address to the master node 210. The master node 210 may update, in real-time, the list or queue of web addresses stored in the database 208. Further, the worker nodes 212 may extract and store the data associated with each depth level of a web address. For example, the worker nodes 212 may extract the data in HTML format and store the extracted data into a corresponding storage space 214-1, 214-2, . . . , 214-N. In an example, the worker nodes 212 may interact with different elements of each web address to extract the data of interest, such as the HTML data. In addition, the system 200 may employ a storage unit 216, such as a Remote Dictionary Server (Redis) cluster, to store the data extracted by each worker node 212.

In an embodiment, the Redis cluster may maintain an index of all parsed web addresses. In an example, the master node 210 may create the index of all parsed web addresses in the Redis cluster. Before a worker node 212 initiates parsing of a new web address, the worker node 212 may check for the new web address in the index maintained in the Redis cluster. If the new web address is not located in the index, it may indicate that the worker nodes 212 have not yet parsed the new web address. Thus, parsing may be initiated on the new web address. On the other hand, if the new web address is located in the index, it may indicate that the worker nodes 212 have already parsed the new web address. Thus, redundant parsing of same web address may be avoided.

Once the data extracted by the worker nodes 212 is stored in the storage unit 214, the crawling engine 204 may compare each keyword pattern with the data crawled on the plurality of sources. In an example, the crawling engine 204 may employ a string and pattern matching technique to match the patterns found on the data crawled on the plurality of sources. Examples of the string and pattern matching technique may include, but are not limited to, Aho-Corasick technique, KMP technique. For matching the keyword patterns, the crawling engine 204 may check for the keyword pattern in the data crawled on the plurality of sources. If the keyword is found in the data crawled on the plurality of sources, the keyword pattern may be stored as MATCH FOUND along with various attributes of a source for which the data has been crawled.

In an example, based on the comparison of the data crawled on the plurality of sources with the pre-stored keyword patterns, the determination engine 206 may be able to identify one or more companies that may have the same context as that of the user input. For example, a keyword pattern may indicate different ways of presenting the same context as that of the keyword(s) input by the user. Thus, upon comparing the extracted data with the pre-stored keyword patterns, the determination engine 206 may identify the companies that have similar context or theme as that indicated by the user input.

In an implementation, the determination engine 206 may compute a confidence score for the context of each of the one or more companies. The confidence score may indicate how relevant a company is for a particular context or theme. The determination engine 206 may compute the confidence score based on various parameters. In an example, for computing the confidence score, the determination engine 206 may determine a type of data source, a frequency of occurrence of the keyword patterns, number of data sources, and so on. In an implementation, the determination engine 206 may associate a weight for the context of each company based on the various parameters.

For example, the determination engine 206 may associate more weight, such as 60% weight, to a home page or depth level 0 of a web address. Therefore, if a keyword pattern is identified at the home page or depth level 0 of the web address, the context associated with the company would be provided a higher confidence score. In another example, the determination engine 206 may associate more weight, such as 70% weight, to a post or article written by a senior executive of a company. Thus, if a keyword pattern is identified in the post or article written by the senior executive of a company, the context associated with the company would be provided a higher confidence score. For instance, a CEO's article would have a higher weightage as compared to a blog. In yet another example, if a keyword pattern appears at multiple data sources (such as web addresses, job listing data, blogs, etc.) related to a company, the context associated with the company would be provided a higher confidence score.

Based on the confidence score, the determination engine 206 may rank the one or more companies. In an example, the determination engine 206 may rank the one or more companies in decreasing order of the confidence score or vice versa. Thus, the user may get a list of all companies that have the same theme or context as that of the user input.

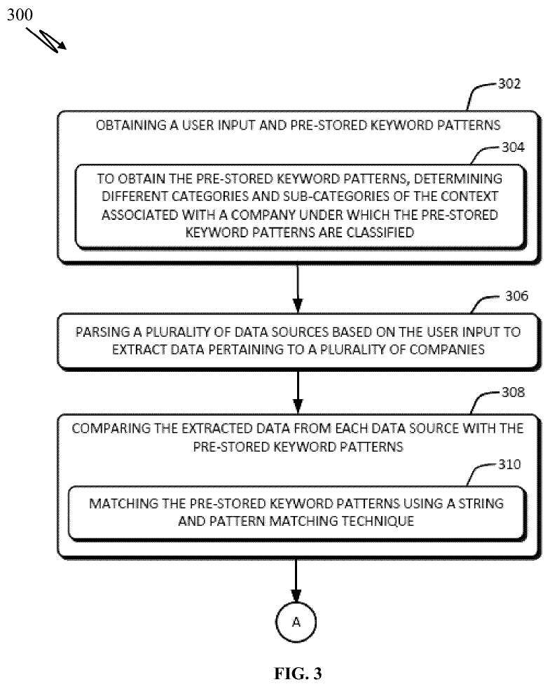

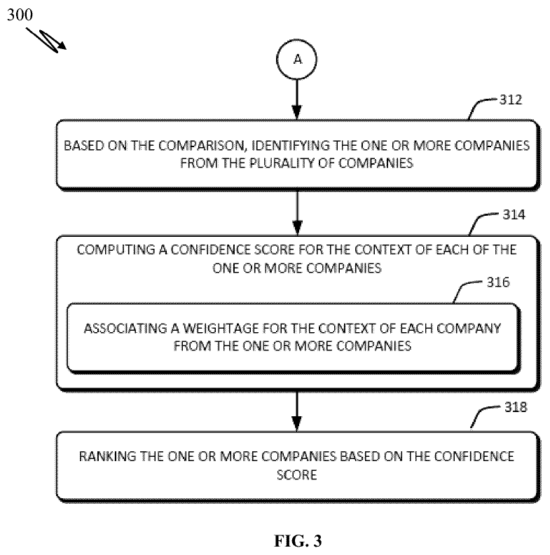

FIG. 3 illustrates flowchart of method 300 for identifying companies based on context associated with a user input, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 is described is not intended to be construed as a limitation, and any number of the described method blocks can be combined in any order to implement the method 300 or alternate methods for determining at least one technology being implemented in one or more companies. Additionally, individual blocks may be deleted from the method 300 without departing from the scope of the subject matter described herein. Furthermore, the methods 300 for identifying companies based on context associated with a user input can be implemented in any suitable hardware, software, firmware, or combination thereof. However, for ease of explanation, in the embodiments described below, the method 300 may be considered to be implemented in the above-described system 102.

The processor 110 may execute the method 300 and other methods described herein. For example, the processor 110 shown in FIG. 1 may execute machine readable instructions stored in the memory 114 to execute the method 300. Although particular reference is made herein to the processor 110 executing the method 300, another device or multiple devices may execute the method 300 without departing from the scope of the method 300.

Referring to FIG. 3, at block 302, the method 300 may include obtaining a user input and pre-stored keyword patterns. The user input may include one or more keywords based on which the companies may be identified. In an example, a keyword pattern may be indicative of a word or a phrase which is contextually similar as a particular keyword. In an implementation, the input engine 118 may obtain the user input and the pre-stored keyword patterns.

At block 304, the method 300 may include to obtain the pre-stored keyword patterns, determining different categories and sub-categories of the context associated with a company under which the pre-stored keyword patterns are classified. In an implementation, the input engine 118 may determine the different categories and sub-categories of the pre-stored keyword patterns.

At block 306, the method 300 may include parsing a plurality of data sources based on the user input, to extract data pertaining to a plurality of companies. A data source may indicate any location in the public domain from where the data is parsed for the purposes of present invention. For example, the data may exist in a home page of a company as a slogan or in fragments of a code that has been used for building a website or may be available in a careers page. For the purposes of the present invention and not by way of any limitation, the plurality of data sources may include, web addresses of companies, and job listing data. In an implementation, the crawling engine 120 may parse the plurality of data sources to extract data pertaining to the plurality of companies.

At block 308, the method 300 may include comparing the extracted data from each data source with the pre-stored keyword patterns. In an implementation, the crawling engine 120 may compare the extracted data from each data source with the pre-stored keyword patterns.

As depicted at block 310, the method 300 may further include matching the pre-stored keyword patterns using a string and pattern matching technique. For example, to compare the extracted data with the pre-stored keyword patterns, the crawling engine 120 may employs an Aho-Corasick technique.

At block 312, the method 300 may include identifying the one or more companies from the plurality of companies, based on the comparison. In an implementation, the determination engine 122 may identify the one or more companies that may have a context similar to the context of the user input.

At block 314, the method 300 may include computing a confidence score for the context of each of the one or more companies. In an implementation, the determination engine 122 may compute the confidence score based on various parameters. In an example, for computing the confidence score, the determination engine 122 may determine a type of data source, a frequency of occurrence of the keyword patterns, number of data sources, and so on.

At block 316, the method 300 may include associating a weight for the context of each company from the one or more companies. In an implementation, the determination engine 122 may associate the weight based on the various parameters. For example, the determination engine 122 may associate more weight to a home page or depth level 0 of a web address. Therefore, if a keyword pattern is identified at the home page or depth level 0 of the web address, the context associated with the company would be provided a higher confidence score. In another example, the determination engine 122 may associate highest weight to a post or article written by a senior executive of a company. Thus, if a keyword pattern is identified in the post or article written by the senior executive of a company, the context associated with the company would be provided a higher confidence score.

Further, at block 318, the method 300 may include ranking the one or more companies based on the confidence score. In an implementation, the determination engine 122 may rank the one or more companies. For example, the determination engine 122 may rank the one or more companies in an increasing or a decreasing order of the confidence score. Furthermore, the determination engine 122 may generate a report to indicate the one or more keywords input by the user and the confidence score for the one or more companies associated with the keywords.

What has been described and illustrated herein are examples of the disclosure along with some variations. The terms, descriptions, and figures used herein are set forth by way of illustration only and are not meant as limitations. Many variations are possible within the scope of the disclosure, which are intended to be defined by the following claims and their equivalents in which all terms are meant in their broadest reasonable sense unless otherwise indicated.

1. A method for identifying one or more companies based on a context associated with a user input, the method comprising:
obtaining, by an input engine, the user input and pre-stored keyword patterns;
parsing, by a crawling engine, a plurality of data sources based on the user input to extract data pertaining to a plurality of companies, wherein the parsing includes navigating a web address at multiple depth levels indicating a number of levels inside the web address;
comparing, by the crawling engine, the extracted data, from each data source, with the pre-stored keyword patterns by using a string and pattern matching technique, wherein the pre-stored keyword patterns are indicative of a word or a phrase contextually similar to the user input;
based on the comparison, identifying, by a determination engine, the one or more companies from the plurality of companies, wherein a context of the one or more companies matches with the context of the user input;
computing, by the determination engine, a confidence score for the context of each of the one or more companies by associating a weight corresponding to a depth level inside the web address on which the context of the one or more companies is being matched with the context of the user input; and
ranking, by the determination engine, the one or more companies based on the confidence score,
wherein the parsing by the crawling engine employs distributed data processing architecture to facilitate bulk parsing of the data sources.

2. The method as claimed in claim 1, wherein obtaining the pre-stored keyword patterns comprises determining different categories and sub-categories of the context associated with a company under which the pre-stored keyword patterns are classified.

3. The method as claimed in claim 1, wherein comparing the extracted data comprises matching a keyword pattern from the pre-stored keyword patterns, using a string and pattern matching technique.

4. The method as claimed in claim 1, wherein associating the confidence score comprises determining a type of data source, frequency of occurrence of keyword patterns, and a number of data sources.

5. (canceled)

6. A system for identifying one or more companies based on a context associated with a user input, the system comprising:
a memory; and
a processor coupled to the memory, wherein the processor is configured to execute program instructions stored in the memory to:
obtain the user input and pre-stored keyword patterns;
parse a plurality of data sources based on the user input to extract data pertaining to a plurality of companies, wherein the parsing includes navigating a web address at multiple depth levels indicating a number of levels inside the web address;
compare, the extracted data, from each data source, with the pre-stored keyword patterns by using a string and pattern matching technique, wherein the pre-stored keyword patterns is indicative of a word or a phrase contextually similar to the user input;
based on the comparison, identify the one or more companies from the plurality of companies, wherein a context of the one or more companies matches with the context of the user input;
compute a confidence score for the context of each of the one or more companies; and
rank, the one or more companies based on the confidence score,
wherein the parsing by the crawling engine employs distributed data processing architecture to facilitate bulk parsing of the data sources.

7. The system as claimed in claim 6, wherein to obtain the pre-stored keyword patterns, the processor is configured to determine different categories and sub-categories of the context associated with a company under which the pre-stored keyword patterns are classified.

8. The system as claimed in claim 6, wherein to compare the extracted data, the processor is configured to match a keyword pattern from the pre-stored keyword patterns using a string and pattern matching technique.

9. The system as claimed in claim 6, wherein to associate the confidence score, the processor is configured to determine a type of data source, frequency of occurrence of keyword patterns, and a number of data sources.

10. (canceled)

11. A non-transitory computer program product having embodied thereon a computer program for, identifying one or more companies based on a context associated with a user input, the computer program product storing instructions, the instructions comprising instructions for:
obtaining the user input and pre-stored keyword patterns;
parsing a plurality of data sources based on the user input to extract data pertaining to a plurality of companies, wherein the parsing includes navigating a web address at multiple depth levels indicating a number of levels inside the web address, wherein the pre-stored keyword patterns is indicative of a word or a phrase contextually similar to the user input;
comparing the extracted data, from each data source, with the pre-stored keyword patterns by using a string and pattern matching technique;
based on the comparison, identifying, the one or more companies;
associating, a confidence score with the context of each of the one or more companies from the plurality of companies, wherein a context of the one or more companies matches with the context of the user input; and
ranking, the one or more companies based on the confidence score,
wherein the parsing by the crawling engine employs distributed data processing architecture to facilitate bulk parsing of the data sources.

12. The method as claimed in claim 1, wherein the string and pattern matching technique includes one of an Aho-Corasick technique and a KMP technique.

13. The system as claimed in claim 6, wherein the string and pattern matching technique includes one of an Aho-Corasick technique and a KMP technique.

14. The method as claimed in claim 1, wherein the confidence score is computed based on a set of parameters comprising a type of data source, a frequency of occurrence of the keyword patterns, and number of data sources.

15. The system as claimed in claim 6, wherein the determination engine computes the confidence score based on a set of parameters comprising a type of data source, a frequency of occurrence of the keyword patterns, and number of data sources.
